(19) United States
(12) Patent Application Publication
(10) Pub. No.: US 2013/0013224 A1
(43) Pub. Date: Jan. 10, 2013

(54) Strain Measuring Method, Strain Measuring Device and Program

(75) Inventors: Yukihiro Ito, Saga (JP); Kenyu Inoue, Saga (JP); Hiroshi Matsuda, Nagasaki (JP); Masakazu Uchino, Fukuoka (JP)

(73) Assignee: Smart Structures LLC, Rantoul, IL (US)

(21) Appl. No.: 13/394,116

(22) PCT Filed: Sep. 2, 2010
(86) PCT No.: PCT/JP2010/065069

§ 371 Date: Sep. 28, 2012

(30) Foreign Application Priority Data
Sep. 3, 2009 (JP) 2009-204164

(51) Int. Cl. G06F 19/00; G01L 1/24

(52) U.S. Cl. 702/42

(57) ABSTRACT

A strain measuring device is provided which is not affected by a change in the intensity and irradiation direction of light received by a measurement target and which enables stable measurement. A computer functions as minute region extracting device for extracting respective surface height distributions of minute regions a and b containing points A and B in a predetermined region from an initial surface height distribution obtained by measuring the predetermined region (6) of the measurement target by a surface height measuring device, coordinate calculating device for calculating coordinates of points A′ and B′ in minute regions a′ and b′ most similar to the minute regions a and b over a time-advanced surface height distribution of the predetermined region 6 and corresponding to the points A and B in the minute regions a and b, respectively, and strain calculating device for calculating a strain in a direction of a line AB of the measurement target.

### TECHNICAL FIELD

The present invention relates to a strain measuring method, a strain measuring device and a program which can measure any strain of an object in a non-contact manner.

### BACKGROUND ART

A loading test is carried out in order to check the mechanical strength of an object needing a mechanical strength, such as a bridge, a dam, a water gate, and other civil constructions, the shell of a ship, the body and wing of an airplane, the frame of a motor, a vehicle, various plants, other machines, or mechanical elements and parts. In general, a loading test is carried out by attaching a strain gauge or a displacement gauge to a test target object and measuring the displacement of the object.

Moreover, a monitoring device is attached to the object to monitor the displacement and strain of the object, and the reduction of the mechanical strength of the object is detected. If the reduction of a mechanical strength is detected and an appropriate repair is applied before a fatal breakage occurs, a disaster can be prevented.

For example, Patent Literature 1 discloses a structure diagnosis method of attaching optical fibers to a diagnosis target element and successively monitoring the strain history of a specific portion of the target element.

Moreover, Patent Literature 2 discloses a method of disposing optical strain sensors at various portions of a ship structure and successively monitoring a dynamic load applied to the ship structure.

Furthermore, Patent Literature 3 discloses a structure monitoring sensor which is attached to the structural body of an airplane and which detects any strain generated by the structural body.

In order to monitor the displacement and strain of an object, it is necessary to attach a sensor to the object, but in the case of, in particular, a large structural object, the work for attaching a sensor and further wiring signal lines of the sensor to a measuring device and a data logger is complicated and costly. Moreover, monitoring of the large structural object is often carried out for a long time, but the maintenance of a monitoring device including the sensor for a long time needs large amount of manpower and costs.

The inventors of the present invention provided a method of analyzing a captured image of a surface of a measurement-target object and calculating any strain of the measurement-target object, which is disclosed in Patent Literature 4. According to such a method, a sensor to be fixed to the measurement-target object becomes unnecessary, and the above-explained problem can be addressed.

### DISCLOSURE OF INVENTION

### Problem to be Solved by the Invention

However, the method disclosed in Patent Literature 4 uses an image captured up by a CCD camera, etc., and is likely to be affected by a lighting condition. In particular, when the measurement-target object is present at an outdoor location, the measurement-target object is irradiated with natural light (solar light), but the lighting intensity and irradiation direction of natural light vary depending on a season, a time or a weather, which makes the measurement unstable. That is, the image quality changes depending on the lighting intensity and the irradiation direction, and thus precise measurement is difficult in some cases.

The present invention has been made in view of such a circumstance, and it is an object of the present invention to provide a strain measuring method, a strain measuring device, and a program which can perform measurement without a sensor fastened to a measurement-target object, i.e., in a non-contact manner, and which are not likely to be affected by the lighting intensity and irradiation direction of light received by the measurement-target object.

### Means for Solving the Problem

To achieve the object, a strain measuring method of the present invention includes: a minute region extracting step of extracting a surface height distribution of a minute region a containing a point A in a predetermined region and a surface height distribution of a minute region b containing a point B in the predetermined region from an initial surface height distribution obtained by measuring a surface height of the predetermined region on a surface of a measurement-target object; a matching step of comparing respective surface height distributions of the minute regions a and b with a time-advanced surface height distribution obtained by measuring a surface height of the predetermined region of the measurement-target object after a time has advanced, and obtaining a minute region a′ over the time-advanced surface height distribution most similar to the surface height distribution of the minute region a and a minute region b′ over the time-advanced surface height distribution most similar to the surface height distribution of the minute region b; a coordinate calculating step of calculating coordinates of points A′ and B′ in the minute regions a′ and b′ corresponding to the points A and B in the minute regions a and b, respectively; and a strain calculating step of substituting a length l of an initial line AB and a length l′ of a time-advanced line A′B′ into a following formula to calculate a strain in a direction of the line AB.

$$ɛ = \frac{{l}^{′} - l}{l} \qquad [ Formula 1 ]$$

The minute region extracting step may extract a surface height distribution of a minute region aᵢ containing a point Aᵢ (i=1, 2, . . . n, where n is a positive integer equal to or greater than two. The same “i” is used for later points and lengths) in the predetermined region and a surface height distribution of a minute region bᵢ containing a point Bᵢ in the predetermined region from the initial surface height distribution, the matching step may compare respective surface height distributions of the minute regions aᵢ and bᵢ with the time-advanced surface height distribution to obtain minute regions a′ᵢ and b′ᵢ over the time-advanced surface height distribution most similar to respective surface height distributions of the minute regions aᵢ and bᵢ, the coordinate calculating step may calculate coordinates of a point A′ᵢ in the minute region a′ᵢ and a point B′ᵢ in the minute region b′ᵢ corresponding to the points Aᵢ and Bᵢ in the minute regions aᵢ and bᵢ, and the strain calculating step may obtain a strain εᵢ in a direction of a line AᵢBᵢ based on a length lᵢ of a line AᵢBᵢ and a length l′ᵢ a line A′ᵢB′ᵢ, and calculate an integrated average of all strains ε₁ as a strain of the predetermined region.

The strain calculating step may calculate an integrated average while excluding an abnormal value from all strains εᵢ.

The abnormal value may be a value outside a preset range.

The abnormal value may be a maximum value or a minimum value of all strains εᵢ.

The strain measuring method may further include a trench cutting step of replacing a surface height of a region where a surface height of a surface height distribution obtained by measuring a surface height of the predetermined region is equal to or smaller than an average value with the average value.

The strain measuring method may further include a predetermined region processing step of processing the predetermined region of the measurement-target object in advance to form a concavo-convex surface.

A strain measuring device according to the present invention includes: a minute region extracting device for extracting a surface height distribution of a minute region a containing a point A in a predetermined region and a surface height distribution of a minute region b containing a point B in the predetermined region from an initial surface height distribution obtained by measuring a surface height of the predetermined region on a surface of a measurement-target object; a matching device for comparing respective surface height distributions of the minute regions a and b with a time-advanced surface height distribution obtained by measuring a surface height of the predetermined region of the measurement-target object after a time has advanced, and obtaining a minute region a′ over the time-advanced surface height distribution most similar to the surface height distribution of the minute region a and a minute region b′ over the time-advanced surface height distribution most similar to the surface height distribution of the minute region b; a coordinate calculating device for calculating coordinates of points A′ and B′ in the minute regions a′ and b′ corresponding to the points A and B in the minute regions a and b, respectively; and a strain calculating device for substituting a length l of an initial line AB and a length l′ of a time-advanced line A′B′ into a following formula to calculate a strains in a direction of the line AB.

The minute region extracting device may extract a surface height distribution of a minute region a; containing a point Aᵢ (i=1, 2, . . . n, where n is a positive integer equal to or greater than two. The same “i” is used for later points and lengths) in the predetermined region and a surface height distribution of a minute region bᵢ containing a point Bᵢ in the predetermined region from the initial surface height distribution, the matching device may compare respective surface height distributions of the minute regions aᵢ and bᵢ with the time-advanced surface height distribution to obtain minute regions a′ᵢ and b′ᵢ over the time-advanced surface height distribution most similar to respective surface height distributions of the minute regions aᵢ and bᵢ the coordinate calculating device may calculate coordinates of a point A′ᵢ in the minute region a′ᵢ and a point B′ᵢ in the minute region b′ᵢ corresponding to the points Aᵢ and Bᵢ in the minute regions aᵢ and bᵢ, and the strain calculating device may obtain a strain εᵢ in a direction of a line AᵢBᵢ based on a length lᵢ of a line AᵢBᵢ and a length l′ᵢ of a line A′ᵢB′ᵢ, and calculate an integrated average of all strains εᵢ as a strain of the predetermined region.

The strain measuring device may further include a trench cutting device for replacing a surface height of a region where a surface height of a surface height distribution obtained by measuring a surface height of the predetermined region is equal to or smaller than an average value with the average value.

A program according to the present invention is installed on a computer and causes the computer to act as a strain measuring device that has the following functions: a minute region extracting device for extracting a surface height distribution of a minute region a containing a point A in a predetermined region and a surface height distribution of a minute region b containing a point B in the predetermined region from an initial surface height distribution obtained by measuring a surface height of the predetermined region on a surface of a measurement-target object; a matching device for comparing respective surface height distributions of the minute regions a and b with a time-advanced surface height distribution obtained by measuring a surface height of the predetermined region of the measurement-target object after a time has advanced, and obtaining a minute region a′ over the time-advanced surface height distribution most similar to the surface height distribution of the minute region a and a minute region b′ over the time-advanced surface height distribution most similar to the surface height distribution of the minute region b; a coordinate calculating device for calculating coordinates of points A′ and B′ in the minute regions a′ and b′ corresponding to the points A and B in the minute regions a and b, respectively; and a strain calculating device for substituting a length l of an initial line AB and a length l′ of a time-advanced line A′B′ into a following formula to calculate a strain E in a direction of the line AB.

The minute region extracting device may extract a surface height distribution of a minute region aᵢ containing a point Aᵢ (i=1, 2, . . . n, where n is a positive integer equal to or greater than two. The same “i” is used for later points and lengths n the predetermined region and a surface height distribution of a minute region bᵢ containing a point Bᵢ in the predetermined region from the initial surface height distribution, the matching device may compare respective surface height distributions of the minute regions aᵢ and bᵢ with the time-advanced surface height distribution to obtain minute regions a′ᵢ and b′ᵢ over the time-advanced surface height distribution most similar to respective surface height distributions of the minute regions aᵢ and bᵢ, the coordinate calculating device may calculate coordinates of a point A′ᵢ in the minute region a′ᵢ and a point B′ᵢ in the minute region b′ᵢ corresponding to the points Aᵢ and Bᵢ in the minute regions aᵢ and bᵢ, and the strain calculating device may obtain a strain εᵢ in a direction of a line AᵢBᵢ based on a length lᵢ of a line AᵢBᵢ and a length l′ᵢ of a line A′ᵢB′ᵢ, and calculate an integrated average of all strains εᵢ as a strain of the predetermined region.

The program of the present invention installed on the computer may further cause the computer to function as the strain measuring device including trench cutting device for replacing all surface heights equal to or smaller than an average value among surface heights of the predetermined region from a surface height distribution obtained by measuring a surface height of the predetermined region with the average value to obtain the initial surface height distribution and the time-advanced surface height distribution.

### Effect of the Invention

According to the present invention, a strain is measured based on the surface height distribution of a measurement-target object, enabling a strain measurement that is not affected by the intensity and irradiation direction of light received by the measurement-target object. Moreover, it becomes unnecessary to always attach a sensor and a gauge to the measurement-target object, and thus a maintenance work for such sensor and gauge becomes unnecessary.

### BRIEF DESCRIPTION OF DRAWINGS

FIG. 1 is a diagram showing a conceptual configuration of an illustrative strain measuring system according to an embodiment of the present invention;

FIG. 2 is a diagram showing a conceptual configuration of a surface height measuring device;

FIG. 3 is a conceptual diagram showing a surface height distribution of a measurement target obtained by the surface height measuring device;

FIG. 4 is a conceptual diagram of a data matrix showing a surface height distribution;

FIG. 5 is a diagram showing a conceptual configuration of a computer;

FIG. 6 is a conceptual diagram for explaining a method of estimating the displacement of a point on a surface of a measurement target;

FIG. 7 is a conceptual diagram for explaining a method of calculating a strain εₓ in an X-axis direction;

FIG. 8 is a conceptual diagram for explaining a method of calculating a strain ε_{y} in a Y-axis direction;

FIG. 9 is a conceptual diagram for explaining a method of calculating a strain ε_{xy} in the diagonal-line direction of the X and Y axes;

FIG. 10 is a flowchart showing an outline of a minute region extracting program;

FIG. 11 is a conceptual diagram for explaining a relationship between a predetermined region and a minute region;

FIG. 12 is a flowchart showing an outline of a matching program;

FIG. 13 is a conceptual diagram for explaining a relationship between a subset a and a subset a′;

FIG. 14 is a flowchart showing an outline of a coordinate calculating program;

FIG. 15 is a conceptual diagram for explaining a quadric curve interpolation of a correlation coefficient C;

FIG. 16 is a flowchart showing an outline of a strain calculating program;

FIG. 17 is a flowchart showing an outline of an averaging program;

FIG. 18 is a conceptual diagram for explaining a trench cutting process;

FIG. 19 is a flowchart showing an outline of a trench cutting program;

FIG. 20 is a diagram showing a configuration of a test piece, etc., used for a test;

FIG. 21 is a graph showing a test result; and

FIG. 22 is a graph showing a test result having undergone a trench cutting process.

### BEST MODE FOR CARRYING OUT THE INVENTION

The best mode for carrying out the invention will be explained with reference to the accompanying drawings as needed.

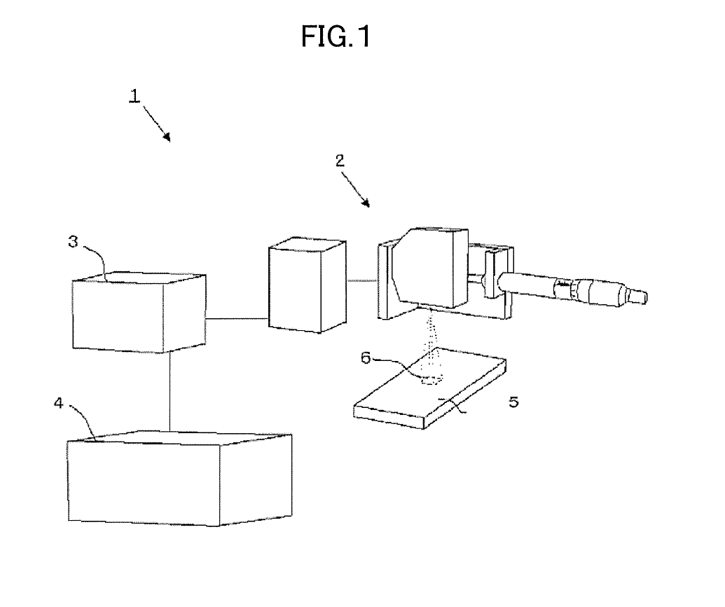

A strain measuring system of the present invention employs a configuration as shown in, for example, FIG. 1. That is, a strain measuring system 1 includes a surface height measuring device 2, a data logger 3, and a computer 4.

The surface height measuring device 2 is to measure the surface height of a predetermined region 6 of a measurement target 5, and the detailed configuration of such a device will be discussed later.

The data logger 3 records data indicating a surface height distribution of the predetermined region 6 obtained by the surface height measuring device 2. The form and configuration, etc., of the data logger 3 are not limited to any particular ones. A device that can freely write and read data processed by the strain measuring system 1 can be selected from the conventionally well-known devices.

The computer 4 analyzes the surface height distribution of the predetermined region 6 in the surface of the measurement target 5 measured by the surface height measuring device 2 and recorded in the data logger 3, and calculates a strain of the predetermined region 6. The detailed configuration of such a computer will be discussed later.

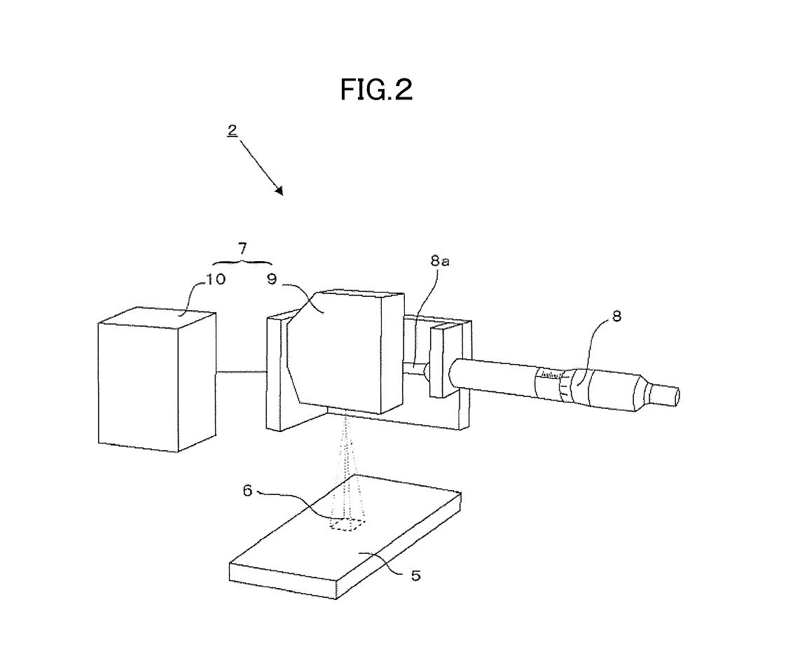

The surface height measuring device 2 employs a configuration shown in FIG. 2. That is, the surface height measuring device 2 includes a two-dimensional laser displacement gauge 7 and a precise feeder 8. Moreover, the two-dimensional laser displacement gauge 7 includes a sensor head 9 and a controller 10.

The two-dimensional laser displacement gauge 7 includes an emitter that emits laser light to the measurement target and an imaging element that captures an image by collecting the laser light reflected by the measurement target, and measures a surface height of the measurement target based on an image of the laser light captured by the imaging element. The detailed configuration and principle of the two-dimensional laser displacement gauge used in this embodiment are disclosed in, for example, Unexamined Japanese Patent Application KOKAI Publication No. 2006-20399, Unexamined Japanese Patent Application KOKAI Publication No. 2006-45926, etc., and the explanation thereof will be omitted in this specification.

The precise feeder 8 is for repeatedly moving the two-dimensional laser displacement gauge 7 by a predetermined minute distance, and in this embodiment, a micrometer is used as the precise feeder 8. That is, the sensor head 9 is fastened to the tip of a spindle 8a of the micrometer, and the spindle 8a is moved forward/backward by the predetermined minute distance, thereby moving the sensor head 9.

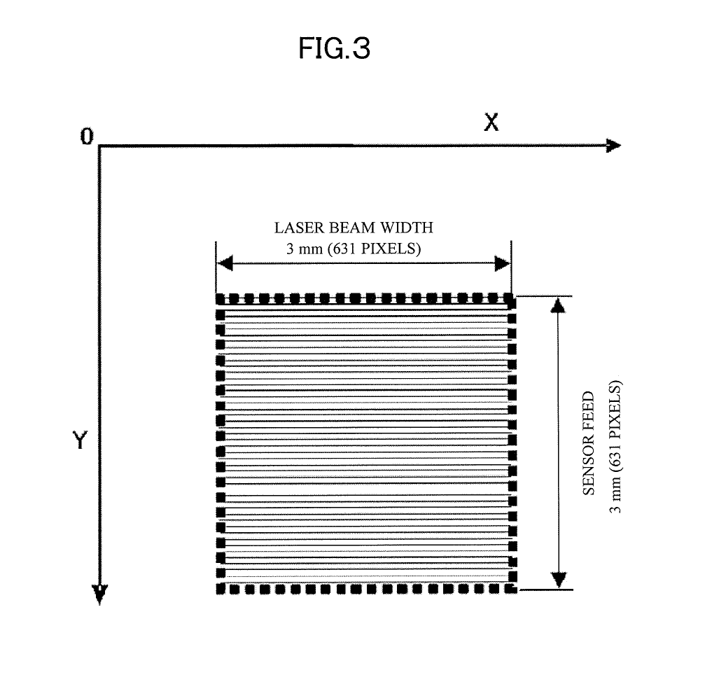

FIG. 3 is a conceptual diagram of a surface height distribution of the predetermined region 6 in the surface of the measurement target 5 obtained by the surface height measuring device 2. In FIG. 3, an X axis corresponds to the width direction of laser beam emitted to the measurement target 5 by the two-dimensional laser displacement gauge 7, and a Y axis corresponds to the feeding direction by the precise feeder 8. The surface height of the predetermined region 6 is indicated by a coordinate in an unillustrated Z axis.

The two-dimensional laser displacement gauge 7 emits laser beam with a width of 3 mm in the X-axis direction to the measurement target 5, decomposes the image of the laser beam reflected by the measurement target 5 by 631 pixels, and calculates the height of the measurement target 5, i.e., a Z-axis coordinate for each pixel. Hence, according to the two-dimensional laser displacement gauge 7, respective Z-axis coordinates of 631 points arranged side by side in a line in the X-axis direction at a pitch of substantially 4.8 μm on the surface of the measurement target 5 can be obtained for each measurement, and the obtained coordinate values are recorded in the data logger 3 in a predetermined format.

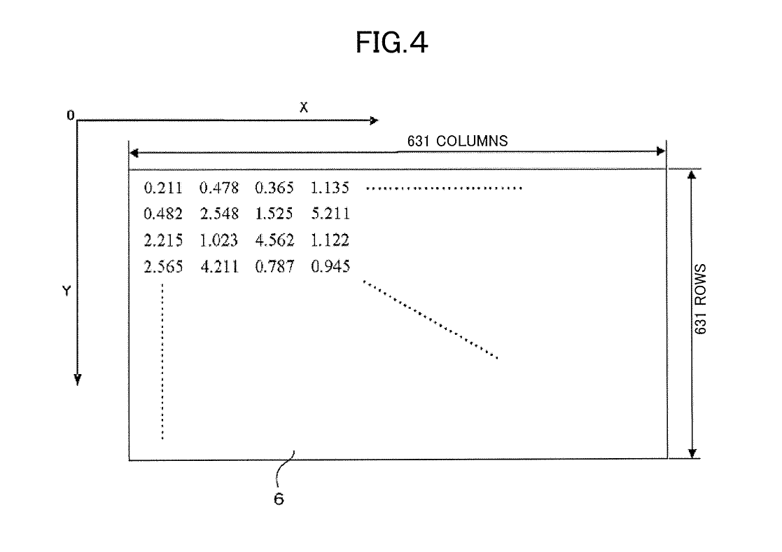

When a measurement by the two-dimensional laser displacement gauge 7 completes (when Z-axis coordinates of 631 points arranged side by side in the X-axis direction are obtained), the precise feeder 8 is operated to move the sensor head 9 by substantially 5 μm in the Y-axis direction, and a measurement by the two-dimensional laser displacement gauge 7 is performed. When this is repeated by 631 times, respective Z-axis coordinates of 398,161 (=631×631) points disposed in a matrix manner in the predetermined region 6 having a dimension with a width of substantially 3 mm and a height of substantially 3.2 mm on the surface of the measurement target 5 can be recorded in the data logger 3. That is, the distribution of surface heights of the predetermined region 6 is recorded in the data logger 3 in the form of a data matrix of 398,161 records shown in FIG. 4.

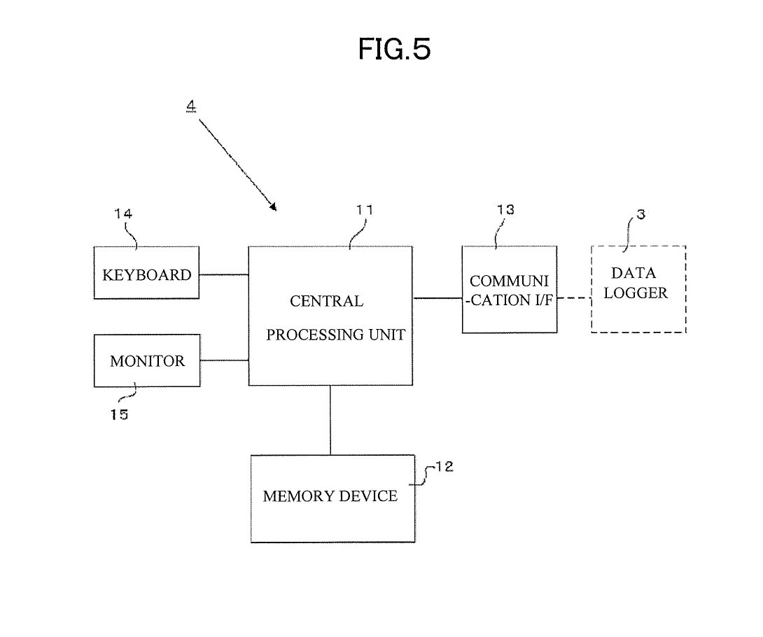

The computer 4 employs a configuration shown in, for example, FIG. 5. That is, the computer 4 includes a central processing unit 11, a memory device 12, a communication interface 13, a keyboard 14, and a monitor 15, etc. The computer 4 is operated through the keyboard 14, and the central processing unit 11 runs a program stored in the memory device 12. Moreover, the central processing unit 11 reads data from the data logger 3 through the communication interface 13 in accordance with the program, executes a predetermined process, displays a result thereof on the monitor 15, and records such a result in the memory device 12. Furthermore, the central processing unit can output a process result to an unillustrated printer through the communication interface 13. Alternatively, the process result can be transmitted to unillustrated another computer.

Next, a brief explanation will be given of the principle of the strain measuring system 1.

In general, a structural object is designed so that a load can be applied with on a surface, and thus a strain in the out-of-plane direction (the thickness direction of a plate) of such a surface is sufficiently smaller than a strain in the in-plane direction of such a surface. For example, when a load is applied to an XY plane of the measurement target 5, the measurement target 5 deforms in the XY plane, but hardly changes in the Z-axis direction. Hence, a minute region in the surface of the measurement target 5 moves in the XY plane while maintaining the surface height distribution in the minute region.

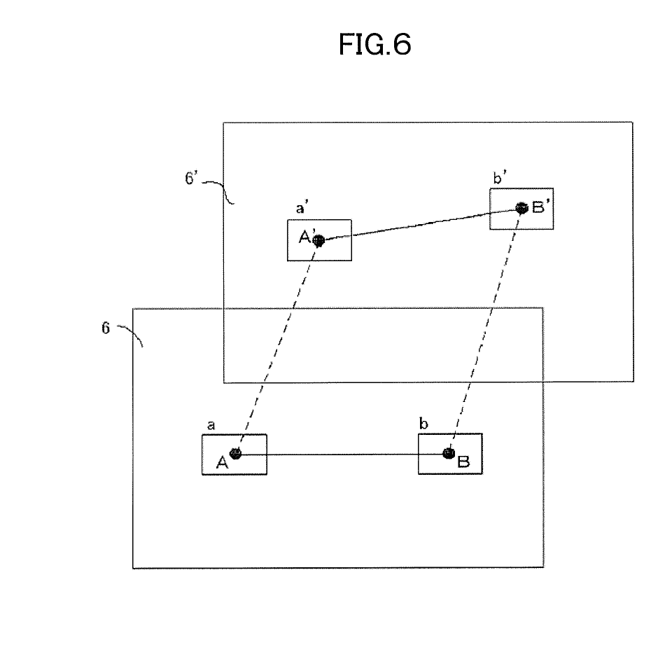

Hence, as shown in FIG. 6, before a load is applied to the measurement target 5, the surface height distribution within the predetermined region 6 is measured, respective surface height distributions of a minute region a containing a point A in the predetermined region 6 and a minute region b containing another point B in the predetermined region 6 (in this example, minute regions a and b containing the points A and B located at respective centers of the minute regions a and b are set) are obtained, and the surface height distribution in the predetermined region 6′ after the load is applied to the measurement target 5 is measured. If minute regions a′ and b′ having the surface height distributions most similar to those of the minute regions a and b in a predetermined region 6′ are found, it can be estimated that the points A and B in the predetermined region 6 are moved to points A′ in the minute region a′ and B′ in the minute region b′ (in this example, the points A′ and B′ are located at respective centers of the minute regions a′ and b′) corresponding to the points A and B of the minute regions a and b, respectively.

When the distance between the points A and B in the predetermined region 6 before a load is applied, i.e., the length of a line AB is 1, and the distance between the points A′ and B′ in the predetermined region 6′ after the load is applied, i.e., the length of a line A′B′ is l′, a strain ε produced between the points A and B by the application of the load can be obtained from the following formula.

$$ɛ = \frac{{l}^{′} - l}{l} \qquad [ Formula 2 ]$$

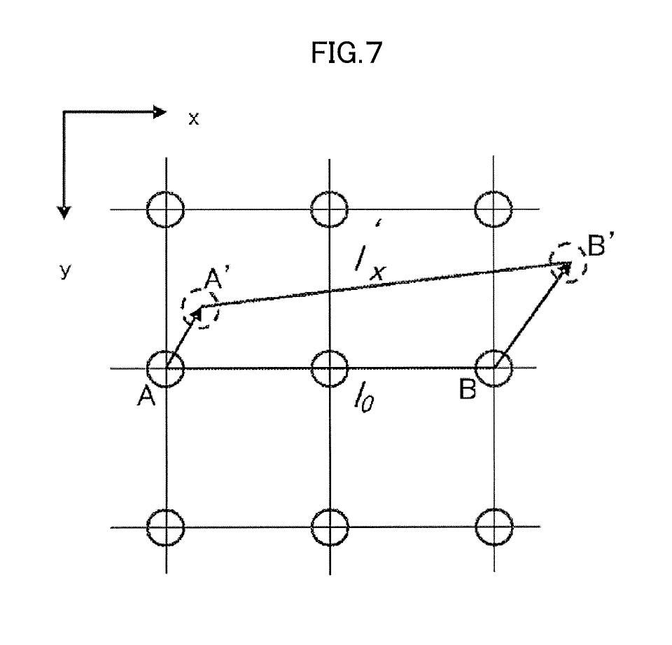

Moreover, as shown in FIG. 7, if selection is made so that the points A and B are arranged side by side in the X-axis direction, a strain εₓ in the X-axis direction can be obtained from the following formula.

$${ɛ}_{x} = \frac{{l}_{x}^{′} - {l}_{0}}{{l}_{0}} \qquad [ Formula 3 ]$$

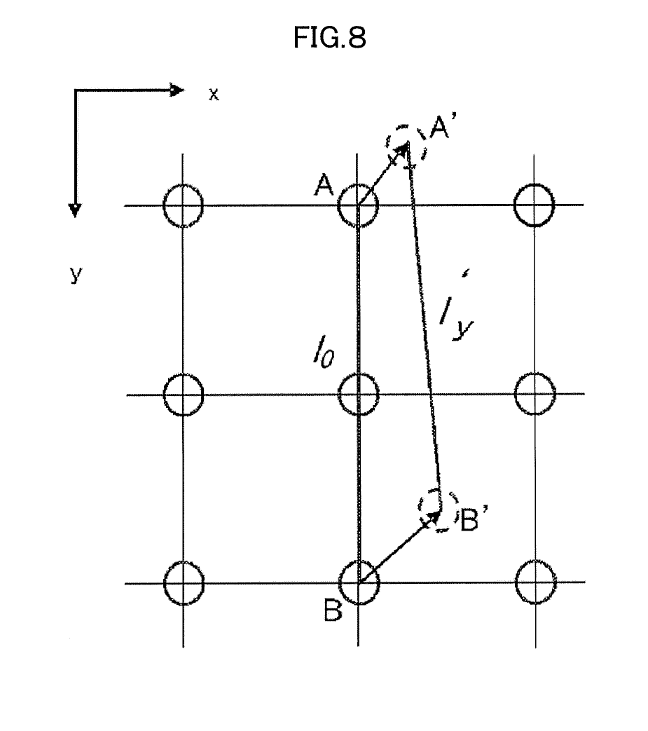

Furthermore, as shown in FIG. 8, if selection is made so that the points A and B are arranged side by side in the Y-axis direction, a strain ε_{y} in the Y-axis direction can be obtained from the following formula.

$${ɛ}_{y} = \frac{{l}_{y}^{′} - {l}_{0}}{{l}_{0}} \qquad [ Formula 4 ]$$

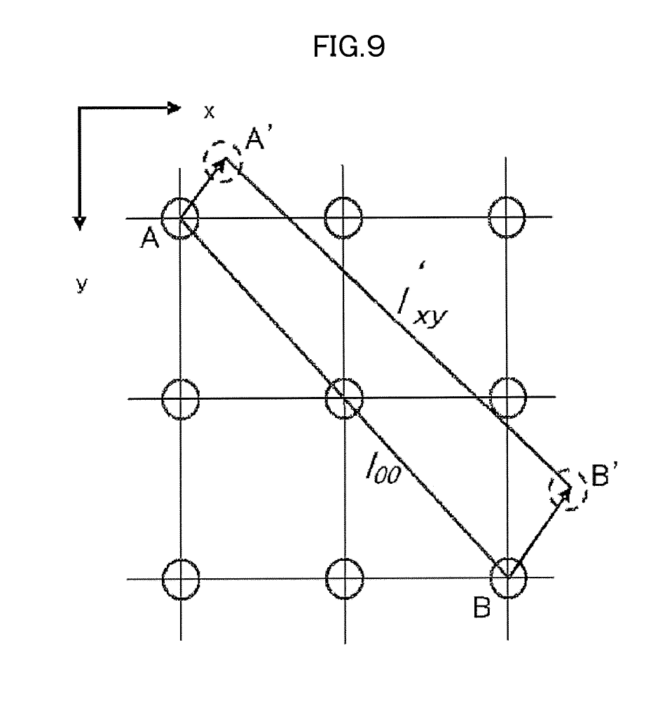

Still further, as shown in FIG. 9, if selection is made so that the points A and B are arranged side by side in the diagonal line direction of the X and Y axes, a strain ε_{xy} in the diagonal line direction can be obtained from the following formula.

$${ɛ}_{xy} = \frac{{l}_{xy}^{′} - {l}_{00}}{{l}_{00}} \qquad [ Formula 5 ]$$

When εₓ, ε_{y}, and ε_{xy} can be obtained, a major strain γₘₐₓ can be obtained from the following formula.

$${γ}_{max} = \sqrt{2 \{ {( {ɛ}_{x} - {ɛ}_{xy} )}^{2} + {( {ɛ}_{y} - {ɛ}_{xy} )}^{2} \}} \\ {ɛ}_{1} = \begin{matrix}1 \\ 2\end{matrix} ( {ɛ}_{x} + {ɛ}_{y} + {γ}_{max} ) \\ {ɛ}_{2} = \frac{1}{2} ( {ɛ}_{x} + {ɛ}_{y} - {γ}_{max} ) \qquad [ Formula 6 ]$$

Through the similar procedures, it can be known that a plurality of points A₁ and Bᵢ (i=1, 2, . . . n, where n is a positive integer greater than or equal to two) in the predetermined region 6 move to points A′ᵢ and B′ᵢ (i=1, 2, . . . n) after a load is applied, and a strain εᵢ can be obtained from a length lᵢ of a line AᵢBᵢ and a length l′ᵢ of a line A′ᵢB′ᵢ. The sum of strains εᵢ (i=1, 2, . . . n) can be divided by n to obtain an integrated average εₘₑₐₙ of the strains εᵢ (i=1, 2, . . . n) which represents a strain in the predetermined region 6.

According to the above-explained method, the strain ε is obtained based on only the length of the line AB and that of the line A′B′, and thus the length of a line AA′ and that of a line BB′ do not affect the value of the strain ε (see FIG. 6). Hence, the reproducibility of the relative position between the surface height measuring device 2 and the measurement target 5 does not affect the measurement precision of the strain ε. Accordingly, before a load is applied to the measurement target 5, when the surface height measuring device 2 is fixed to the measurement target 5, the height distribution in the predetermined region 6 is measured, the surface height measuring device 2 is detached from the measurement target 5, and the surface height measuring device 2 fixed again to the measurement target 5 after a time has elapsed, it is sufficient if the surface height measuring device 2 is positioned at a precision level such that the predetermined region 6 is included in the detection range of the surface height measuring device 2. This is because even if the relative position of the surface height measuring device 2 is slightly shifted to the measurement target 5 and respective lengths of the lines AA′ and line BB′ change, respective lengths of the lines AB and A′B′ remain same.

The surface height (a Z coordinate) of the predetermined region 6 is indicated by a coordinate fixed to the surface height measuring device 2, but if, for example, an average of the surface heights of the predetermined region 6 is obtained and the surface height distribution of the predetermined region 6 is indicated by a relative height based on such an average, the relative height of the surface height measuring device 2 to the measurement target 5 does not affect the indication of the surface height distribution of the predetermined region 6. Hence, the reproducibility of the relative position in the height direction (Z-axis direction) when the surface height measuring device 2 is attached to the measurement target 5 does not affect the measurement precision of the strain ε.

Based on the above-explained principle, in order to calculate the strain ε of the measurement target 5 from the surface height distribution of the predetermined region 6, the following programs are installed in the memory device 12 of the computer 4, and the central processing unit 11 runs such programs.

(1) Minute region extracting program

(2) Matching program

(3) Coordinate calculating program

(4) Strain calculating program

(5) Averaging program

(6) Trench cutting program

Respective outline flows of such programs will be explained below.

[Minute Region Extracting Program]

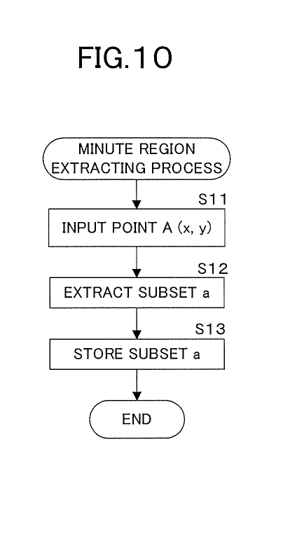

The minute region extracting program extracts, from the surface height distribution (initial surface height distribution) of the predetermined region 6 measured before a load is applied to the measurement target 5, surface height distributions of minute regions a and b near the points A and B in the predetermined region 6, and mainly executes a process shown in FIG. 10.

First, coordinates of the point A(x, y) are input (step S11). Inputting of the coordinates (x, y) is manually carried out using the keyboard 14 or automatically carried out by an upper-level program.

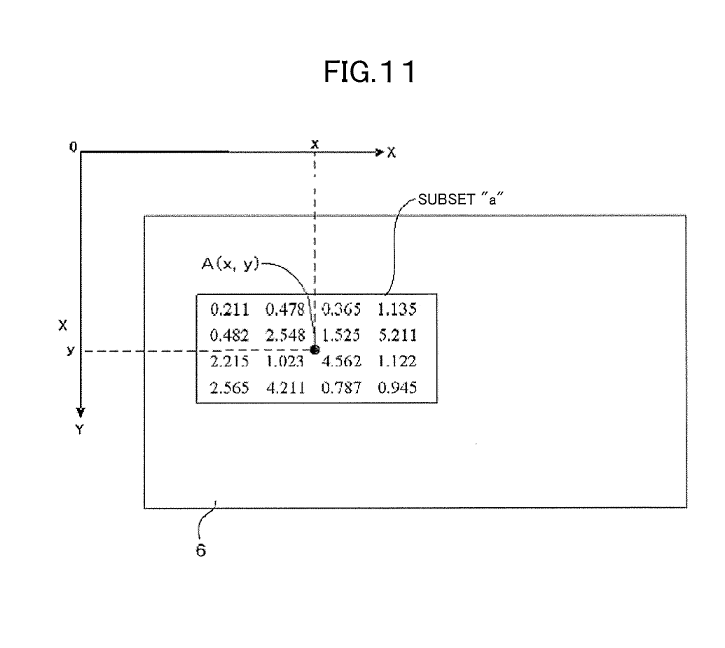

Next, as shown in FIG. 11, a data matrix belonging to the minute region a near the coordinates (x, y) is extracted from the data matrix indicating the initial surface height distribution of the whole predetermined region 6 (hereinafter, the data matrix belonging to the minute region a is referred to as a “subset a”). When, for example, the subset a has a size of four columns by four rows, elements within ranges from the second top row to the second bottom row of the coordinates (x, y) of the data matrix with 631 columns by 631 rows indicating the initial surface height distribution of the predetermined region 6 and from the second left column to the second right column are picked up to extract the subset a (step S12).

Finally, the subset a is stored in the memory device 12 (step S13), and the minute region extracting program is deactivated.

[Matching Program]

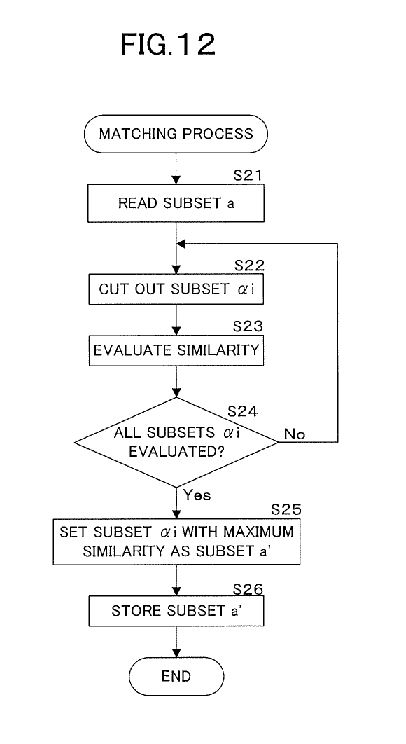

The matching program checks the subset a extracted by the minute region extracting program with the measured surface height distribution (time-advanced surface height distribution) of the predetermined region 6 after a load is applied to the measurement target 5, obtains a subset a′ most similar to the subset a and over the time-advanced surface height distribution, and mainly executes a process shown in FIG. 12.

First, the subset a is read from the memory device 12 (step S21). Next, a subset αᵢ is cut out from the data matrix indicating the time-advanced surface height distribution (step S22), and the similarity to the subset a is evaluated (step S23).

The evaluation on the similarity of the subset αᵢ with the subset a is performed on all subsets αᵢ included in the data matrix indicating the time-advanced surface height distribution, and when the evaluation of the similarity of all subsets αᵢ completes (step S24: YES), the process progresses to step S25, and the subset αᵢ with the maximum similarity with the subset a, i.e., the subset αᵢ most similar to the subset a is set as a subset a′.

Thereafter, the subset a′ is stored in the memory device 12 (step S26), and the matching program is deactivated.

The evaluation of the similarity of the subset uses the following correlation coefficient C.

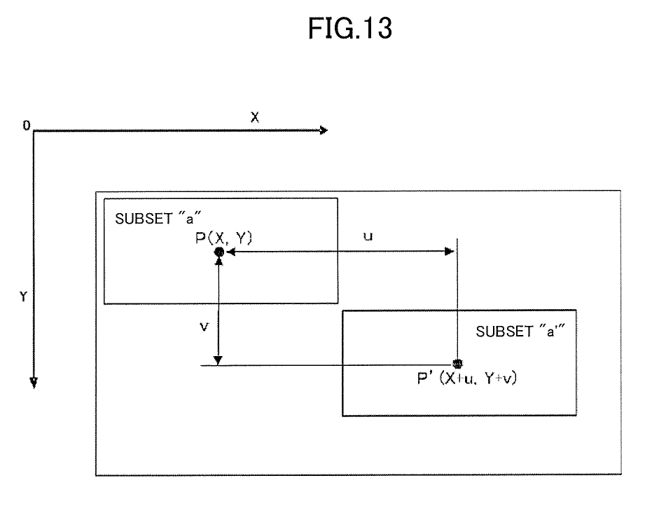

That is, as shown in FIG. 13, when the center coordinates of the subset a are P(X, Y) and the center coordinates of the subset a′ are P′(X+u, Y+v), the correlation coefficient C of the subset a′ to the subset a can be expressed by the following formula.

$$C ( X + u , Y + v ) = {\sum }_{j = - M}^{M} {\sum }_{i = - M}^{M} \vert Zd ( X + u + i , Y + v + j ) - Zu ( X + i , Y + j ) \vert \qquad [ Formula 7 ]$$

In the above formula, Zu(X+i, Y+j) and Zd(X+u+i, Y+v+j) are heights of corresponding points of the subset a and the subset a′ (Z coordinates). M is an integer that satisfies M=2N−1 when respective sizes of the subset a and the subset a′ are N columns by N rows. That is, the correlation coefficient C is a total of the absolute values of the differences in the heights (Z coordinates) of the corresponding points of the subset a and the subset a′, and the smaller the correlation coefficient C is, the higher the similarity of the subset a′ to the subset a is.

Hence, if the correlation coefficient C is calculated for all u, v, and u, v minimizing the correlation coefficient C are set, it becomes possible to set the subset a′ most similar to the subset a.

Alternatively, the correlation coefficient C expressed by the following formula can be used.

$$C ( X + u , Y + v ) = 1 - \frac{\begin{matrix}{\sum }_{j = - M}^{M} {\sum }_{i = - M}^{M} Zd ( X + u + i , Y + v + j ) \times \\ {\sum }_{j = - M}^{M} {\sum }_{i = - M}^{M} Zu ( X + i , Y + j )\end{matrix}}{\sqrt{\begin{matrix}{( {\sum }_{j = - M}^{M} {\sum }_{i = - M}^{M} Zd ( X + u + i , Y + v + j ) )}^{2} \times \\ {( {\sum }_{j = - M}^{M} {\sum }_{i = - M}^{M} Zu ( X + i , Y + j ) )}^{2}\end{matrix}}} \qquad [ Formula 8 ]$$

[Coordinate Calculating Program]

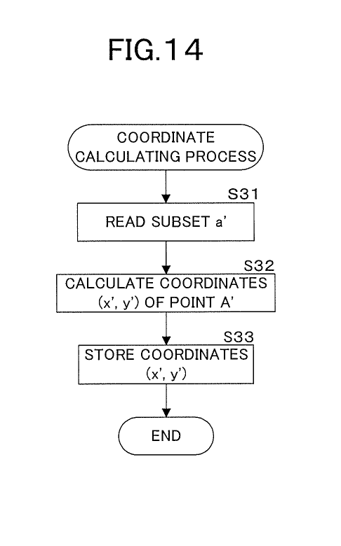

The coordinate calculating program calculates coordinates of a center point of the subset, and mainly executes a process shown in FIG. 14. That is, first, the subset a′, etc., is read from the memory device 12 (step S31). Next, the coordinates (x′, y′) of a center point A′ of the subset a′ are calculated (step S32), the coordinates (x′, y′) are stored in the memory device 12 (step S33), and the process is terminated.

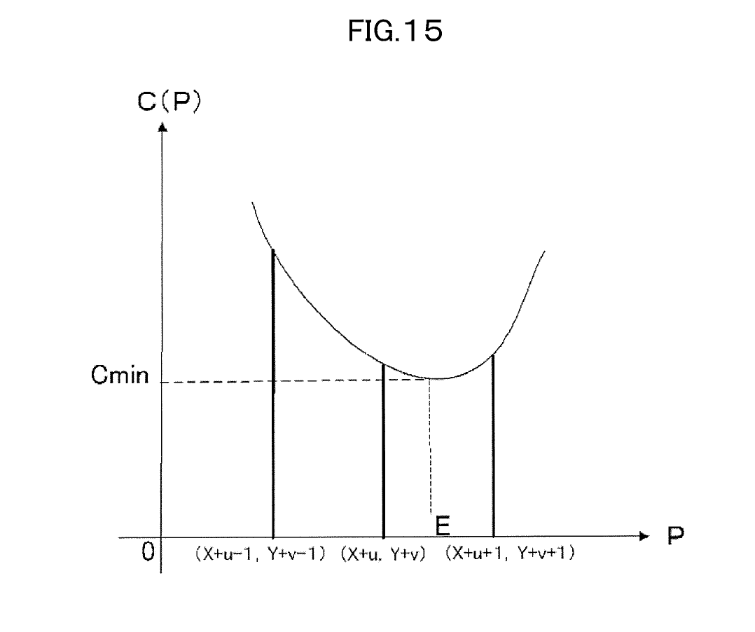

Before a load is applied to the measurement target 5, the coordinates (x′, y′) of the point A′ is obtained based on a presumption that the point A located at the coordinates (x, y) moves to the center point A′ of the subset a′, but as shown in FIG. 15, differences between the correlation coefficients C(X+u−1, Y+v−1), C(X+u, Y+v), and C(X+u+1, Y+v+1) obtained discretely can be subjected to approximate interpolation by a quadric curve, and the coordinates of a point E where the correlation coefficient C becomes minimum can be taken as the coordinates (x′, y′) of the point A′. When such approximate interpolation is performed, estimation of the displacement becomes precise.

[Strain Calculating Program]

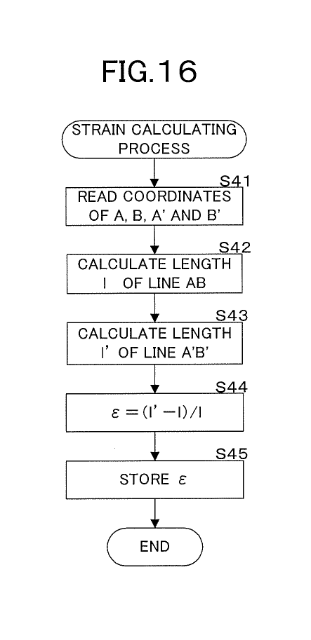

The strain calculating program calculates a strain of the measurement target 5 in the direction of the line AB by figuring out that the points A and B in the predetermined region 6 before a load is applied to the measurement target 5 move to the points A′ and B′ after the load is applied to the measurement target 5 through the matching program and the coordinate calculating program, and mainly executes a process shown in FIG. 16.

That is, first, respective coordinates of the points A, B, A′ and B′ are read from the memory device 12 (step S41). Next, the length l of the line AB is calculated (step S42), and the length l′ of the line A′B′ is also calculated (step S43).

Subsequently, the strain ε of the measurement target 5 in the direction of the line AB is calculated based on the following formula (step S44), a result is stored in the memory device 12 (step S45), and the process is terminated.

$$ɛ = \frac{{l}^{′} - l}{l} \qquad [ Formula 9 ]$$

[Averaging Program]

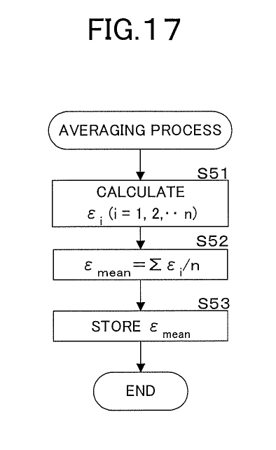

The averaging program obtains strains εᵢ in the plural directions of lines AᵢBᵢ (i=1, 2, . . . n, where n is a positive integer equal to or greater than two) within the predetermined region 6, calculates an integrated average thereof, and mainly executes a process shown in FIG. 17.

That is, programs from the minute region extracting program to the strain calculating program are repeatedly executed to calculate strains εᵢ (i=1, 2, . . . n) (step S51), the total of the strains εᵢ (i=1, 2, . . . n) are divided by n to calculate the integrated average εₘₑₐₙ (step S52), a result is stored in the memory device 12 (step S53), and the process is terminated.

εᵢ (i=1, 2, . . . n) may include an abnormal value due to an error, etc., at the time of measurement. In this case, if εᵢ (i=1, 2, . . . n) are directly added together to calculate the integrated average εₘₑₐₙ, the value of the integrated average εₘₑₐₙ also becomes different from the true value. Hence, if a threshold is set and εᵢ (i=1, 2, . . . n) exceeding such a threshold is excluded from the calculating of the integrated average εₘₑₐₙ, the reliability of the integrated average εₘₑₐₙ can be enhanced.

Alternatively, the integrated average εₘₑₐₙ may be calculated by excluding the maximum and minimum values of εᵢ (i=1, 2, . . . n).

[Trench Cutting Program]

The strain measuring system 1 measures the heights of 398,161 (=631×631) points in the predetermined region 6 with a size of substantially 3 mm×3 mm through the surface height measuring device 2, and obtains the surface height distribution of the predetermined region 6. The measured value of a portion of the predetermined region 6 with a low surface height (a trench) may include an abnormal value. This abnormal value is derived from the characteristic of the two-dimensional laser displacement gauge 7, and it is difficult to eliminate such an abnormal value. Accordingly, there is a technical issue that the measured value of the portion of the predetermined region 6 with a low surface height has a poor reliability.

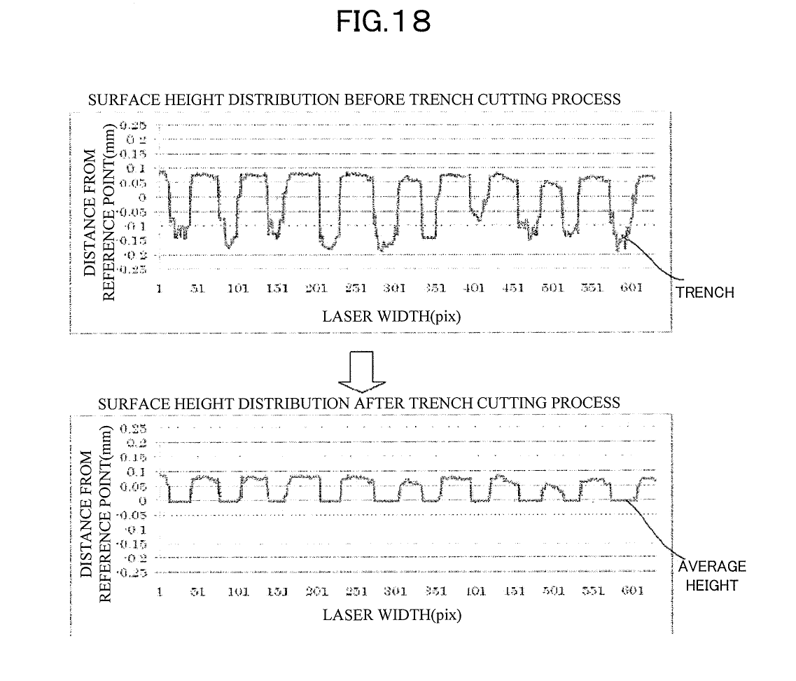

Hence, as shown in FIG. 18, if the surface height distribution of the predetermined region 6 measured by the surface height measuring device 2 is processed by the trench cutting program to calculate an average value of the surface heights of the predetermined region 6, all surface heights of the portions having a surface height equal to or smaller than the average value are replaced with the average value, the above technical issue can be solved.

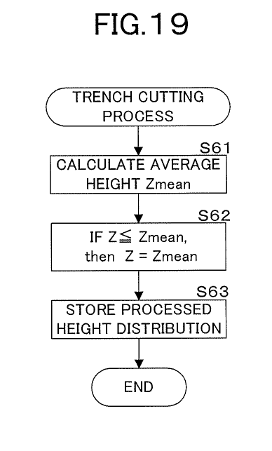

The trench cutting program mainly executes a process shown in FIG. 19. That is, an average value Zₘₑₐₙ of the surface height of the predetermined region 6 is calculated (step S61), and when an element Z of the data matrix indicating the surface height distribution of the predetermined region 6 is equal to or smaller than Zₘₑₐₙ, the value of Z is replaced with Zₘₑₐₙ (step S62). A result is stored in the memory device 12 (step S63), and the process is terminated.

### Example

### Test

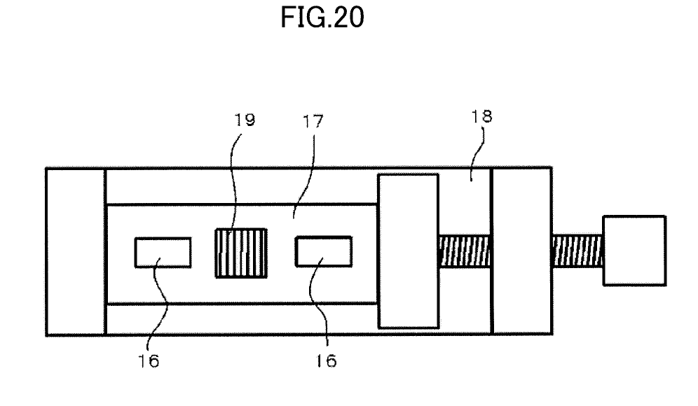

As shown in FIG. 20, a test piece 17 attached with a strain gauge 16 was held by a precise vise 18, a compression load was applied to the test piece 17, and a strain applied to the test piece 17 at that time was measured through the strain measuring system 1 and the strain gauge 16. Respective measured values were compared with each other.

The test piece 17 was a cut piece of an aluminum (JIS A6063) square bar of 10 mm×10 mm with a length of 25 mm. The surface of the test piece 17 was repeatedly beaten substantially parallel to the test peace 17 by a flat chisel to form a concavo-convex surface 19. The surface height distribution of this concavo-convex surface 19 was measured through the surface height measuring device 2 of the strain measuring system 1.

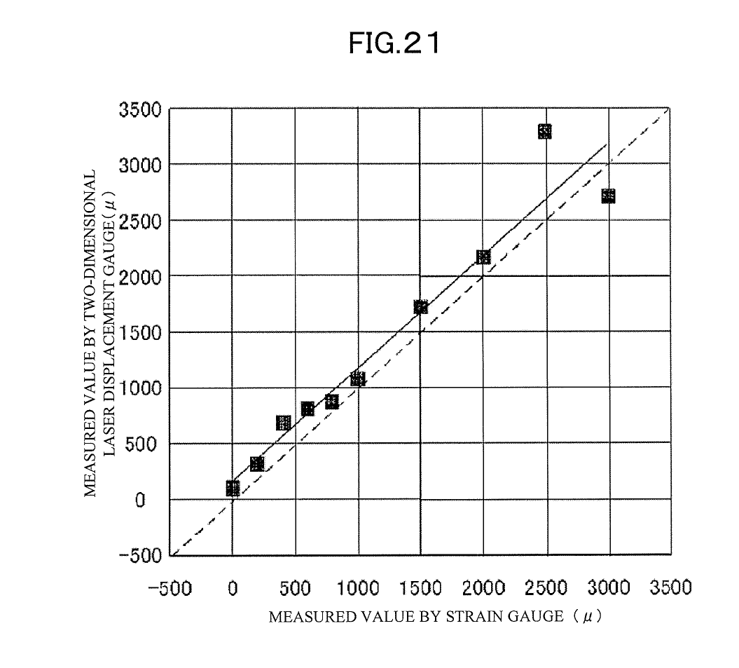

FIG. 21 is a diagram plotted with test results (black square marks) and having a horizontal axis indicating a measured value by the strain gauge 16 and a vertical axis indicating a measured value by the strain measuring system 1. If the test results were aligned on a diagonal line (a dashed line) of the figure, the measured value by the strain measuring system 1 and that of the strain gauge 16 were consistent with each other. As shown in FIG. 21, both values are almost consistent with each other.

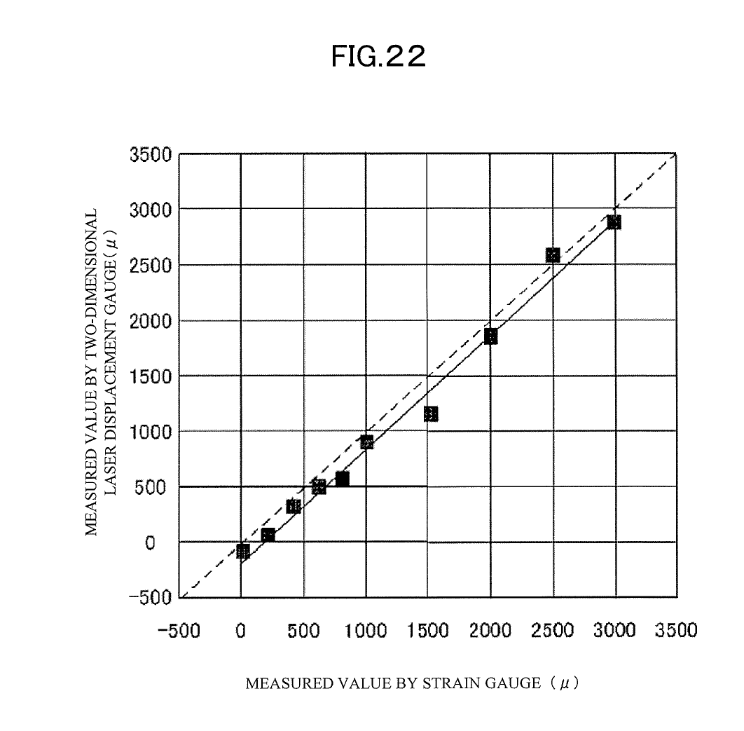

Moreover, FIG. 22 shows a relationship between a result of obtaining a strain of the test piece 17 by executing the above-explained trench cutting process on the surface height distribution of the concavo-convex surface 19 measured by the surface height measuring device 2 of the strain measuring system 1 and a measured value by the strain gauge 16.

When FIG. 22 is compared with FIG. 21, it becomes clear that execution of the trench cutting process on the surface height distribution further improves the consistency of the measured value by the strain measuring system 1 with the measured value by the strain gauge 16. That is, the measurement precision of the strain measuring system 1 further improves.

In this specification, an example case was explained in which the points A, B, A′, and B′ are respectively located at centers of the minute regions a, b, a′, and b′, but the points A, B, A′, and B′ may be located at other positions than the centers of respective minute regions a, b, a′, and b′. For example, the minute regions a and b may be set in such a way that the points A and B are respectively located at 70% of the widths (a dimension in the row direction) of the minute regions a and b and at 30% of the heights (a dimension in the column direction) thereof. In this case, the positions of the points A′ and B′ in the minute regions a′ and b′ correspond to the positions of the points A and B in the minute regions a and b, and respective coordinates of the points A′ and B′ defined by the positions located at 70% of the widths (a dimension in the row direction) of the minute regions a′ and b′, and at 30% of the heights (a dimension in the column direction) thereof.

As explained above, according to the present invention, a strain of the surface of an object is measured based on the surface height distribution of the object obtained by measuring the height of the surface of the object. Hence, it becomes unnecessary to attach a gauge, a sensor, etc., to the surface of the object.

Accordingly, when, in particular, a strain of a large structural object placed at an outdoor location is measured for a long time, it is unnecessary to consider the durabilities of the gauge, the sensor, etc., making the measurement easy.

Moreover, according to the present invention, it is unnecessary to wire a lead, a cable, etc., for measurement to the measurement-target object. Hence, the present invention is especially suitable for measurement of a strain of a portion that needs a complicated wiring like a rotor of a rotating machine.

Specific example applications of the present invention are preventive maintenance of a bridge (e.g., a stress concentrated part of a bridge beam), a vehicle (e.g., an axes shaft), a ship (e.g., an important structural member), an airplane (e.g., the beam of a main wing), a motor (e.g., a rotor blade of a turbine).

In this specification, the explanation was given of an example case in which the test piece 17 was beaten by the flat chisel to form the concavo-convex surface 19, i.e., a strain was obtained from the height distribution of a surface where concavity and convexity were artificially and purposefully formed. The application of the present invention is not limited to such an object. According to the present invention, it becomes possible to measure a strain based on not only a concavo-convex surface formed artificially and purposefully but also irregular and minute concavity and convexity (a surface height) originally contained in a material of an object.

Alternatively, a portion subjected to a strain measurement may be processed in advance to form the concavo-convex surface appropriate for a strain measurement by the present invention.

Moreover, the range of the field to which the present invention is applicable may become widespread together with the development of the technology of measuring minute concavity and convexity on the surface of an object.

In this specification, the explanation was given of the example case in which the precise feeder 8 (micrometer) is manually operated to move the sensor head 9 of the two-dimensional laser displacement gauge 7, and the surface height distribution of the predetermined region 6 is obtained. However, the technical field of the present invention is not limited to the use of the surface height distribution obtained by such a device. The present invention can be carried out using the surface height distribution obtained through various devices and methods.

For example, the precise feeder 8 may use an electronically-controlled precise actuator, and the two-dimensional laser displacement gauge 7 and the precise feeder 8 may be both controlled by the computer 4 to automatically measure the surface height distribution of the predetermined region 6.

This application is based on Japanese Patent Application No. 2009-204164, filed on Sep. 3, 2009. The entire specification, claims, and drawings of Japanese Patent Application No. 2009-204164 are herein incorporated in this specification by reference.

### INDUSTRIAL APPLICABILITY

The present invention can be utilized as a method and a device which measure a strain of various objects, such as a bridge or a machine, in a non-contact manner, or a program which is installed in a computer and which allows such a computer to function as the above-explained device.

1. A strain measuring method comprising:
a minute region extracting step of extracting a surface height distribution of a minute region a containing a point A in a predetermined region and a surface height distribution of a minute region b containing a point B in the predetermined region from an initial surface height distribution obtained by measuring a surface height of the predetermined region on a surface of a measurement-target object;
a matching step of comparing respective surface height distributions of the minute regions a and b with a time-advanced surface height distribution obtained by measuring a surface height of the predetermined region of the measurement-target object after a time has advanced, and obtaining a minute region a′ over the time-advanced surface height distribution most similar to the surface height distribution of the minute region a and a minute region b′ over the time-advanced surface height distribution most similar to the surface height distribution of the minute region b;
a coordinate calculating step of calculating coordinates of points A′ and B′ in the minute regions a′ and b′ corresponding to the points A and B in the minute regions a and b, respectively; and
a strain calculating step of substituting a length l of an initial line AB and a length l′ of a time-advanced line A′B′ into a following formula to calculate a strains in a direction of the line AB.
$$ɛ = \frac{{l}^{′} - l}{l} \qquad [ Formula 1 ]$$

2. The strain measuring method according to claim 1, wherein
the minute region extracting step extracts a surface height distribution of a minute region aᵢ containing a point Aᵢ (i=1, 2, . . . n, where n is a positive integer equal to or greater than two. The same “i” is used for later points and lengths) in the predetermined region and a surface height distribution of a minute region bᵢ containing a point Bᵢ in the predetermined region from the initial surface height distribution,
the matching step compares respective surface height distributions of the minute regions aᵢ and bᵢ with the time-advanced surface height distribution to obtain minute regions a′ᵢ and b′ᵢ over the time-advanced surface height distribution most similar to respective surface height distributions of the minute regions aᵢ and bᵢ,
the coordinate calculating step calculates coordinates of a point A′ᵢ in the minute region a′ᵢ and a point B′ᵢ in the minute region b′ᵢ corresponding to the points Aᵢ and Bᵢ in the minute regions aᵢ and bᵢ, and
the strain calculating step obtains a strain εᵢ in a direction of a line AᵢBᵢ based on a length lᵢ of a line AᵢBᵢ and a length of a line A′ᵢB′ᵢ, and calculates an integrated average of all strains εᵢ as a strain of the predetermined region.

3. The strain measuring method according to claim 2, wherein the strain calculating step calculates an integrated average while excluding an abnormal value from all strains E.

4. The strain measuring method according to claim 3, wherein the abnormal value is a value outside a preset range.

5. The strain measuring method according to claim 3, wherein the abnormal value is a maximum value or a minimum value of all strains εᵢ.

6. The strain measuring method according claim 1, further comprising a trench cutting step of replacing a surface height of a region where a surface height of a surface height distribution obtained by measuring a surface height of the predetermined region is equal to or smaller than an average value with the average value.

7. The strain measuring method according claim 1, further comprising a predetermined region processing step of processing the predetermined region of the measurement-target object in advance to form a concavo-convex surface.

8. A strain measuring device comprising:
minute region extracting device for extracting a surface height distribution of a minute region a containing a point A in a predetermined region and a surface height distribution of a minute region b containing a point B in the predetermined region from an initial surface height distribution obtained by measuring a surface height of the predetermined region on a surface of a measurement-target object;
matching device for comparing respective surface height distributions of the minute regions a and b with a time-advanced surface height distribution obtained by measuring a surface height of the predetermined region of the measurement-target object after a time has advanced, and obtaining a minute region a′ over the time-advanced surface height distribution most similar to the surface height distribution of the minute region a and a minute region b′ over the time-advanced surface height distribution most similar to the surface height distribution of the minute region b;
coordinate calculating device for calculating coordinates of points A′ and B′ in the minute regions a′ and b′ corresponding to the points A and B in the minute regions a and b, respectively; and
strain calculating device for substituting a length l of an initial line AB and a length l′ of a time-advanced line A′B′ into a following formula to calculate a strain c in a direction of the line AB.
$$ɛ = \frac{{l}^{′} - l}{l} \qquad [ Formula 2 ]$$

9. The strain measuring device according to claim 8, wherein
the minute region extracting device extracts a surface height distribution of a minute region aᵢ containing a point Aᵢ (i=1, 2, . . . n, where n is a positive integer equal to or greater than two. The same “i” is used for later points and lengths) in the predetermined region and a surface height distribution of a minute region bᵢ containing a point Bᵢ in the predetermined region from the initial surface height distribution,
the matching device compares respective surface height distributions of the minute regions aᵢ and bᵢ with the time-advanced surface height distribution to obtain minute regions a′ᵢ and b′ᵢ over the time-advanced surface height distribution most similar to respective surface height distributions of the minute regions aᵢ and bᵢ,
the coordinate calculating device calculates coordinates of a point A′ᵢ in the minute region a′ᵢ and a point B′ᵢ in the minute region b′ᵢ corresponding to the points Aᵢ and Bᵢ in the minute regions aᵢ and bᵢ, and
the strain calculating device obtains a strain εᵢ in a direction of a line AᵢBᵢ based on a length lᵢ of a line AᵢBᵢ and a length l′ᵢ of a line A′ᵢB′ᵢ, and calculates an integrated average of all strains εᵢ as a strain of the predetermined region.

10. The strain measuring device according to claim 8, further comprising trench cutting device for replacing a surface height of a region where a surface height of a surface height distribution obtained by measuring a surface height of the predetermined region is equal to or smaller than an average value with the average value.

11. A program which is installed in a computer and which causes the computer as a strain measuring device that functions as:
minute region extracting device for extracting a surface height distribution of a minute region a containing a point A in a predetermined region and a surface height distribution of a minute region b containing a point B in the predetermined region from an initial surface height distribution obtained by measuring a surface height of the predetermined region on a surface of a measurement-target object;
matching device for comparing respective surface height distributions of the minute regions a and b with a time-advanced surface height distribution obtained by measuring a surface height of the predetermined region of the measurement-target object after a time has advanced, and obtaining a minute region a′ over the time-advanced surface height distribution most similar to the surface height distribution of the minute region a and a minute region b′ over the time-advanced surface height distribution most similar to the surface height distribution of the minute region b;
coordinate calculating device for calculating coordinates of points A′ and B′ in the minute regions a′ and b′ corresponding to the points A and B in the minute regions a and b, respectively; and
strain calculating device for substituting a length l of an initial line AB and a length 1′ of a time-advanced line A′B′ into a following formula to calculate a strains in a direction of the line AB.
$$ɛ = \frac{{l}^{′} - l}{l} \qquad [ Formula 3 ]$$

12. The program according to claim 11, wherein
the minute region extracting device extracts a surface height distribution of a minute region aᵢ containing a point Aᵢ (i=1, 2, . . . n, where n is a positive integer equal to or greater than two. The same “i” is used for later points and lengths) in the predetermined region and a surface height distribution of a minute region bᵢ containing a point Bᵢ in the predetermined region from the initial surface height distribution,
the matching device compares respective surface height distributions of the minute regions aᵢ and bᵢ with the time-advanced surface height distribution to obtain minute regions a′ᵢ and b′ᵢ over the time-advanced surface height distribution most similar to respective surface height distributions of the minute regions aᵢ and bᵢ,
the coordinate calculating device calculates coordinates of a point A′ᵢ in the minute region a′ᵢ and a point B′ᵢ in the minute region b′ᵢ corresponding to the points Aᵢ and Bᵢ in the minute regions aᵢ and bᵢ, and
the strain calculating device obtains a strain εᵢ in a direction of a line AᵢBᵢ based on a length lᵢ of a line AᵢBᵢ and a length l′ᵢ of a line A′ᵢB′ᵢ, and calculates an integrated average of all strains εᵢ as a strain of the predetermined region.

13. The program according to claim 11 installed in the computer and further causes the computer to function as the strain measuring device including trench cutting device for replacing all surface heights equal to or smaller than an average value among surface heights of the predetermined region from a surface height distribution obtained by measuring a surface height of the predetermined region with the average value to obtain the initial surface height distribution and the time-advanced surface height distribution.
